(19) United States
(12) Patent Application Publication
(10) Pub. No.: US 2010/0237763 A1
(43) Pub. Date: Sep. 23, 2010

(54) Cold Cathode Electron Emission Source and Method for Manufacture of the Same

(76) Inventors: Takao Shiraga, Chiba (JP); Kazunori Kitagawa, Chiba (JP); Toshio Kaneshige, Chiba (JP); Norio Nishimura, Chiba (JP)

Correspondence Address: QUARLES & BRADY LLP, 411 E. WISCONSIN AVENUE, SUITE 2040, MILWAUKEE, WI, 53202-4497, US

(21) Appl. No.: 12/726,115

(22) Filed: Mar. 17, 2010

(30) Foreign Application Priority Data
Mar. 19, 2009 (JP) 2009-068035

(51) Int. Cl. H01J 1/30; H01B 13/00

(52) U.S. Cl. 313/336; 216/17

(57) ABSTRACT

The present invention provides a novel method for the manufacture of an enhanced cold cathode electron emission source allowing a measure of area to be processed at one time. The method includes the steps of: dissolving first and second polymers in solvent to obtain a polymer solution, and applying the polymer solution onto a second conductive layer before forming a hole; precipitating and immobilizing the first polymer in a particulate in the second polymer by evaporating the solvent; removing the first polymer particulate with a developer to form an etching hole in the second polymer; and performing etching process via the etching hole so as to form the hole in the second conductive layer. In one embodiment, the second polymer has greater solubility than the first polymer in the solvent, and the first polymer has greater solubility than the second polymer in the developer.

### CROSS-REFERENCE TO RELATED APPLICATIONS

The present Application claims priority to Japanese Patent Application No. 2009-068035 filed Mar. 19, 2009, the entire disclosure of which is expressly incorporated herein by reference.

### BACKGROUND OF THE INVENTION

1. Field of the Invention

The present invention relates to generally a method for the manufacture of a cold cathode electron emission source which includes a first conductive layer, an insulating layer on the first conductive layer, a second conductive layer disposed on the insulating layer and having a hole extending therethrough and through the insulating layer, and an emitter formed on a bottom of the hole and positioned in electrical contact with the first conductive layer, and more particularly, to method for the manufacture of a cold cathode electron emission source allowing a relatively large area to be processed with less time, and allowing holes having diameters varying over a predetermined range to be created, and a cold cathode electron emission source produced by the described method.

2. Description of the Related Art

A conventional spindt-type cold cathode electron emission source has an insulating layer and a gate electrode layer, both of which are disposed on a cathode electrode that is formed on a substrate. A hole is made extending through both the insulating layer and the gate electrode layer. On the bottom of the hole a conical emitter is provided such that it is in electrically contact with the cathode electrode.

In such a conventional spindt-type cold cathode electron emission source, the hole extending through the insulating layer and the gate electrode layer generally has an opening size of about 1 μm. In a case where the opening size is set at 0.1 to 0.2 μm on average, and the thickness of the insulating layer is made thinner, the density of electron emission element is improved, and thus drive voltage is decreased. For example, a method of forming a hole by using a charged particle track is disclosed in Publication of Japanese Patent Application No. H9-504900 (A).

In accordance with the above document, a charged particle randomly passes a track layer having a resist therein, and a charged particle track is randomly formed within the track layer. Subsequently, etching process is performed on the track layer. In this case, the track layer is etched along the charged particle track, and an opening space is created in the corresponding portion of the track layer. Subsequently, an electron emission element is defined in the middle of the opening space. For more detail, refer to Publication of Japanese Patent Application No. H9-504900 (A), in particular, FIGS. 5 and 10.

However, in accordance with the above method, in order to produce high-energy charged particle a relatively large-scale apparatus has generally been required.

Furthermore, when the cold cathode electron emission source is intended for an electron emission source for flat displaying element, an area where the charged particle is uniformly illuminated is substantially limited. Therefore, in a case where a large area such as a display device is to be processed or operated, illumination per unit area is needed to be repeated until the overall area is illuminated. In this case, a large amount of time and expense is needed to such processing or operation.

In order to solve the above problems and drawbacks, it is an object of this invention to provide a method for the manufacture of an improved cold cathode electron emission source allowing a desired area (a relatively large area) to be processed at one time via a simple process without any conventional large-scale apparatus, and an improved cold cathode electron emission source produced by the same method.

### SUMMARY OF THE INVENTION

In accordance with a first aspect of the invention, there is provided a method for the manufacture of a cold cathode electron emission source comprising a first conductive layer; an insulating layer on the first conductive layer; a second conductive layer disposed on the insulating layer and having a hole extending therethrough and through the insulating layer; and an emitter formed on a bottom of the hole and positioned in electrical contact with the first conductive layer. The method specifically includes the steps of:

dissolving a first polymer and a second polymer, which is incompatible or immiscible with the first polymer, in solvent to obtain a polymer solution, and applying the polymer solution onto the second conductive layer prior to forming the hole;

precipitating and immobilizing the first polymer in a form of particulate in the second polymer by evaporating the solvent;

removing the first polymer in the form of particulate by using a developer to form an etching hole in a layer of the second polymer; and

performing etching process via the etching hole to form the hole in the second conductive layer.

In the method, the solvent may be selected such that the second polymer has greater solubility than the first polymer in the solvent, and the developer may be selected such that the first polymer has greater solubility than the second polymer in the developer.

In accordance with the inventive method, the developer may be water or organic solvent.

In accordance with the inventive method, the solvent may be composed of single organic solvent.

In accordance with the inventive method, the solvent may comprise first organic solvent having a relatively high boiling point and second organic solvent having a relatively low boiling point. Preferably, the first polymer has solubility greater than the second polymer in the second organic solvent, and the second polymer has solubility greater than the first polymer in the first organic solvent.

In accordance with the inventive method, the etching process may be dry etching process, and the method may further include the step of forming a protective layer on the layer of the second polymer having the etching hole therein prior to dry etching so as to protect the layer of the second polymer against the dry etching.

In accordance with a second aspect of the invention, there is provided a cold cathode electron emission source, which includes a first conductive layer; an insulating layer on the first conductive layer; a second conductive layer disposed on the insulating layer and having holes extending therethrough and through the insulating layer; and an emitter formed on a bottom of each of the holes and positioned in electrical contact with the first conductive layer. In this configuration, the holes may have diameters varying over a range of from 0.04 μm to 0.3 μm.

### BRIEF DESCRIPTION OF THE DRAWINGS

FIG. 1 is a cross-sectional view showing a frame format of a coating process in an exemplary method for the manufacture of a cold cathode electron emission source in accordance with the present invention.

FIG. 2A is a cross-sectional view showing a frame format of a developing process in an exemplary method for the manufacture of a cold cathode electron emission source in accordance with the present invention, and FIG. 2B is an electron micrograph by a planer view (i.e., photograph 1).

FIG. 3 is a cross-sectional view showing a frame format of a process for forming a protective layer in an exemplary method for the manufacture of a cold cathode electron emission source in accordance with the present invention.

FIG. 4 is a cross-sectional view showing a frame format of a dry etching process in an exemplary method for the manufacture of a cold cathode electron emission source in accordance with the present invention.

FIG. 5A is a cross-sectional view showing a frame format of a peeling-off process in an exemplary method for the manufacture of a cold cathode electron emission source in accordance with the present invention, and FIG. 5B is an electron micrograph by a planer view (i.e., photograph 2).

FIG. 6A is a cross-sectional view showing a frame format of a wet etching process in an exemplary method for the manufacture of a cold cathode electron emission source in accordance with the present invention, and FIG. 6B is an electron micrograph by a planer view (i.e., photograph 3).

FIG. 7 is a cross-sectional view showing a frame format of a process forming a sacrifice layer in an exemplary method for the manufacture of a cold cathode electron emission source in accordance with the present invention.

FIG. 8A is a cross-sectional view showing a frame format of a process for depositing a molybdenum (Mo) layer in an exemplary method for the manufacture of a cold cathode electron emission source in accordance with the present invention, and FIG. 8B is an electron micrograph by a planer view (i.e., photograph 4).

FIG. 9A is a cross-sectional view showing a frame format of a process for removing a molybdenum (Mo) layer in an exemplary method for the manufacture of a cold cathode electron emission source in accordance with the present invention, and FIG. 9B is an electron micrograph by a planer view (i.e., photograph 5).

FIG. 10 is an electron micrograph showing a cross section of a conventional cold cathode electron emission source in which a hole extending through both a electrically conductive gate electrode layer and an insulating layer has an opening diameter of about 1 μm.

FIG. 11A is an isometric electron micrograph of FIG. 10, showing a cross section of a cold cathode electron emission source produced by a method for the manufacture of a cold cathode electron emission source in accordance with the present invention, and FIG. 11B is an enlarged electron micrograph of the main section of FIG. 11A.

FIG. 12 is a histogram showing an exemplary hole diameter distribution in a cold cathode electron emission source produced by a method for the manufacture of a cold cathode electron emission source in accordance with the present invention.

FIGS. 13A to 13C are a view showing a principle of forming a hole in an exemplary method for the manufacture of a cold cathode electron emission source in accordance with the present invention.

### DETAILED DESCRIPTION OF THE INVENTION

Principle of an embodiment of a method for the manufacture of a cold cathode electron emission source in accordance with the present invention.

An embodiment of a method for the manufacture of a cold cathode electron emission source in accordance with the present invention is substantially directed to a method for the manufacture of a cold cathode electron emission source 10 having a substrate 1, a cathode electrode 2 (i.e., a first conductive layer) and a resistive layer 3 disposed on the substrate 1, an insulating layer 4 disposed on the resistive layer 3, an electrically conductive gate electrode layer 5 (i.e., the second conductive layer) formed on the insulating layer 4, and an emitter 7 defined on the resistive layer 3 such that it is positioned in electrical contact with the cathode electrode 2 at the bottom of a hole 6 extending through both the gate electrode layer 5 and the insulating layer 4, as shown in FIG. 9. This embodiment of a method for the manufacture of a cold cathode electron emission source is particularly directed to a method of forming a hole 6 in the gate electrode layer 5. In this configuration, the resistive layer 3 may be omitted. In other words, the emitter 7 may be directly disposed on the cathode electrode 2.

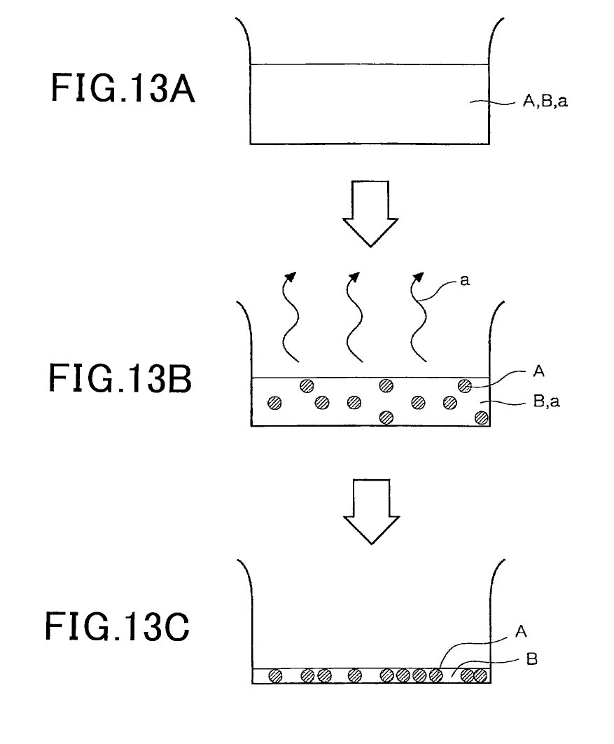

This embodiment is characterized by employing a polymer mask as an etching mask in etching process for forming the hole 6. Referring to FIG. 13A, polymer A (i.e., a first polymer) and polymer B (i.e., a second polymer) which is incompatible or immiscible with polymer A are dissolved in solvent a. Referring to FIG. 13B, as the solvent a is evaporated off, due to phase separation polymer A, which has relatively low solubility in solvent a, in the form of particulate precipitates in the polymer B which has relatively high solubility in solvent a. Referring to FIG. 13C, as the solvent a is further evaporated off, the polymer A in the form of particulate is immobilized or stabilized in the polymer B prior to forming an aggregate together. This phenomenon can be advantageously applied to the inventive method. In other words, after the immobilized particulate polymer A is removed by a developing solution (i.e., a developer) which can selectively dissolve the polymer A, the layer of polymer B having a plurality of fine holes therein is left on the gate electrode layer 5. In an etching process for forming an hole, the layer of polymer B as thus obtained may be employed as a mask, and the hole created by removing the polymer A may be employed as an etching hole. As a result, a relatively fine hole 6 can be formed in the gate electrode layer 5.

First embodiment of a method for the manufacture of a cold cathode electron emission source in accordance with the present invention.

A method for the manufacture of a cold cathode electron emission source 10 will be thereinafter described in detail. The method may include the step of forming the hole 6 in the gate electrode layer 5 in accordance with the afore-mentioned principle, and any other processes or steps, if needed.

In this embodiment, PEI (polyethyleneimine) is employed as the first polymer A having water solubility and desired solubility in an organic solvent which will be described below, and PMMA (polymethyl methacrylate) is employed as the second polymer B which has solubility greater than polymer A in the organic solvent, and is non-soluble in water. Both polymer A and polymer B are mixed with and dissolved in PGMEA (propylene glycol monomethyl ether acetate) and methanol as the organic solvent so as to obtain a polymer solution. In this step, the dissolution of the first and second polymers preferably takes place at the molecular level. This is because the first polymer may be regularly or uniformly dispersed and precipitated.

Mixing ratio of water-soluble polymer A and water-insoluble polymer B is a major factor determinative of formation of the hole. The water-soluble polymer A precipitate should be dispersed throughout the water-insoluble polymer B. In a case where the ratio of the water-soluble polymer A is relatively high, the particles aggregates together thus creating a larger particle without increasing the density of particle. The water-soluble polymer A is employed in a volume of 0.05 to 0.15 with respect to the water-insoluble polymer B in a volume of 1, which demonstrates good results.

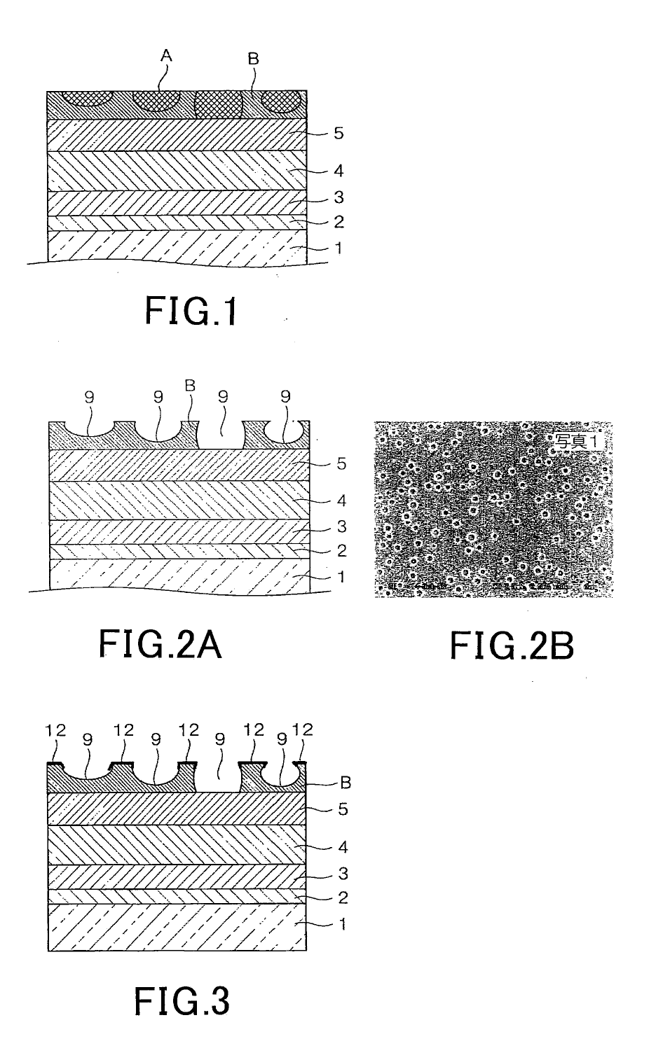

Turning to FIG. 1, a cathode electrode 2 and a resistive layer 3 are formed on the substrate 1, an insulating layer 4 is formed on the resistive layer 3, and an electrically conductive gate electrode layer 5 is formed on the insulating layer 4. The polymer solution comprising the water-soluble polymer A and the water-insoluble polymer B is applied onto the gate electrode layer 5. This process can be called as a “coating process” herein.

In the coating process, the polymer solution can be spread on the gate electrode layer 5 by centrifugal force which is produced when the substrate 1 is rotated. This technology is generally called as a “spin coating” herein. However, independently of film forming (i.e., coating) method and apparatus, roll coating in which the polymer solution is applied onto the substrate 1 by means of a roller, inkjet coating in which the polymer solution is ejected and applied onto the substrate 1 by means of an inkjet apparatus, and the like may be employed, without limitation.

The water-soluble polymer. A particulate precipitate is generally spherical. In this regard, if the thickness of the polymer solution coating were greater than the diameter of the polymer A particulate precipitate, the precipitate would be embedded in the polymer solution coating. As a result, the polymer A precipitate does not allow for the formation of hole in the layer of the polymer B. In addition, the density of particles is lowered, thus causing the process to be inefficient and insufficient. On the other hand, if the thickness of the polymer solution coating were too thin, the subsequent process for forming a protective layer might be adversely affected. In other words, during the process for forming an aluminum layer as a protective layer on the layer of polymer B prior to etching process, the aluminum layer may be deposited onto not only the surface of the polymer B layer but also the bottom of the hole, thus preventing the holes from properly being formed in the gate electrode layer 5 during the subsequent etching process via etching holes. In view of the above, in a case where the diameter of the polymer A particulate precipitate is in the range of about 0.1 μm to about 0.2 μm (1000 Å to 2000 Å), the thickness of the polymer solution coating would be preferably adjusted to the range of about 0.1 μm (1000 Å) to about 0.15 μm (1500 Å).

With reference to FIG. 1, the polymer solution which is applied onto the gate electrode layer 5 is dried. Both polymers A and B are dissolved in the polymer solution such that the water-soluble polymer A is dispersed in the water-insoluble polymer B at the molecular level. Accordingly, when the solvent is evaporated from the polymer solution which is coated onto the gate electrode layer 5, due to phase separation the water-soluble polymer A in the form of particulate precipitates as a discontinuous phase in the water-insoluble polymer B, and a plurality of the water-soluble polymer A particulate precipitates is immobilized in the water-insoluble polymer B to be a base material, as shown in FIG. 1.

As mentioned previously, the principle of formation of the hole may need or utilize the step of precipitation based on the difference in solubility when the solvent is evaporated from the polymer solution comprising two polymers, and the step of immobilizing the resulting precipitates in the matrix of water-insoluble polymer B (also designated as the “base material”) before the precipitates aggregate together. In order to successfully accomplish the formation of hole, two polymers, the water-soluble polymer A and the water-insoluble polymer B should be phase-separated without mixing together. Accordingly, in a case where drying is carried out too rapidly, the precipitated polymer A particulate has a tendency to become smaller. On the other hand, in a case where drying is carried out too slowly, the precipitated polymer A particulate has a tendency to become larger. Therefore, the speed of drying may be empirically determined in consideration of the particle size to be sought, and the other conditions.

Furthermore, if an evaporable organic solvent other than terpineol and the like which is not easily evaporated were employed as the solvent, spin coating technology could be employed as a coating method, and the polymer solution which is applied onto the gate electrode layer 5 could be naturally dried. When the drying is completed, the precipitation process is also completed. However, if solvent having a relatively low evaporativity such as terpineol and the like were employed, drying process or step may be facilitated by heating.

Referring to FIG. 2, the substrate 1 is macerated in water which acts as a developer (i.e., a developing solution) thus dissolving and removing the water-soluble polymer A which is precipitated in the form of particulate. As a result, a hole 9 for etching (i.e., an etching hole 9) is formed in the water-insoluble polymer B. Referring to FIG. 2B (photograph 1), a plurality of etching holes 9 is randomly formed and distributed such that the diameters of the holes are varied at a predetermined range.

Referring to FIG. 3, the protective layer 12 is formed on the layer of the water-insoluble polymer B having the etching hole 9 therein so as to shield or protect the layer of the polymer B from etching. In the embodiment, aluminum is employed as material for the protective layer 12, and is deposited onto the polymer B. The protective layer 12 is configured to protect the surface of the polymer B which does not have sufficient tolerance properties against reactive ionic etching. In the embodiment, the layer of the polymer B having the etching hole 9 therein and having the protective layer thereon may be employed as a mask. The thickness of the protective layer 12 may be the range of from 100 Å to 200 Å.

Aluminum layer may be deposited by means of oblique deposition. In other words, aluminum layer is deposited diagonally (for example, 10 degrees) to the surface of the substrate 1 with the substrate being rotated. The substrate 1 may be rotated while disposed on a rotating table (not shown). In accordance with the oblique deposition, the protective layer 12 is only formed on the surface of the polymer B which is not desired to be removed by etching process, and is not formed both the polymer B which remains at the bottom of the etching hole 9 and the gate electrode layer 5 which is exposed to outside via the etching hole 9.

Referring to FIG. 4, reactive ionic etching may be performed downward from above the protective layer 12. The polymer B disposed inside the etching hole 9, the gate electrode layer 5 below the polymer B disposed inside the hole 9, and the gate electrode layer 5 which is exposed to outside via the etching hole 9 are not protected by the protective layer, and are thus subjected to the reactive ionic etching. In other words, the polymer B disposed inside the etching hole 9, the gate electrode layer 5 below the polymer B disposed inside the hole 9, and the gate electrode layer 5 which is exposed to outside via the etching hole 9 are undercut by reactive ionic etching. As a result, the hole 6 is formed.

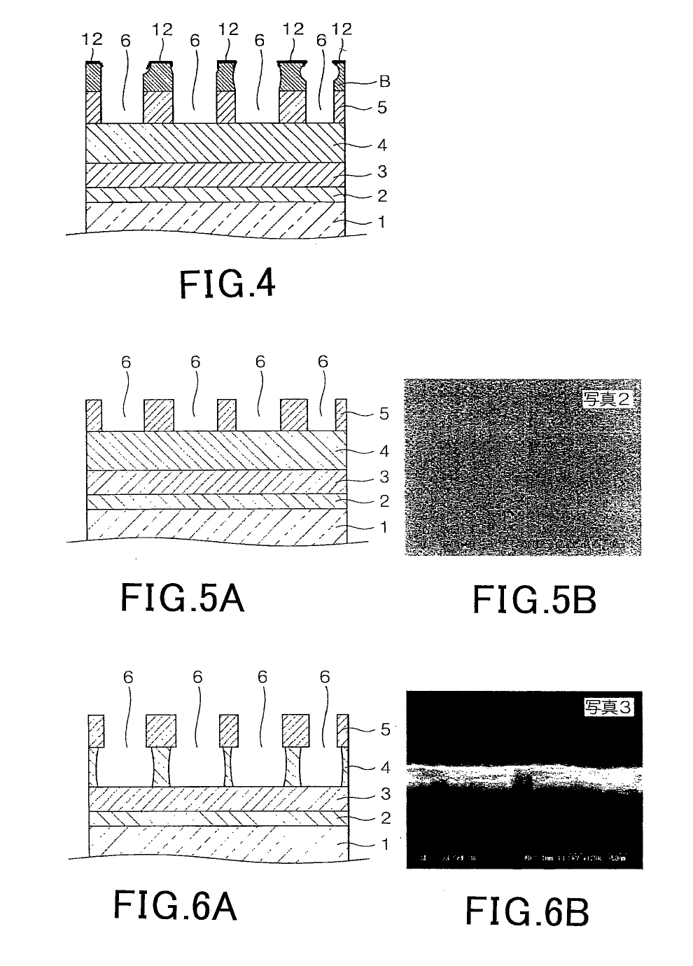

Referring to FIG. 5A, the layer of polymer B together with the protective layer 12 may be removed by alkaline solution and organic solvent. In accordance with FIG. 5B (photograph 2), a plurality of the holes 6 is randomly formed and distributed such that the diameters of the holes are varied at a predetermined range.

Referring to FIG. 6A, fluoric acid is applied to the insulating layer 4 so as to perform wet etching with the gate electrode layer 5 having the hole 6 therein employed as a mask. In this case, a hole communicating with the hole 6 and having a diameter greater than that of the hole 6 extending through the gate electrode layer 5 is newly formed in the insulating layer 4. The surface of the resistive layer 3 is exposed to outside via the hole 6 extending through the insulating layer 4. In accordance with FIG. 6B, the enlarged lower portion of the hole 6 is formed in the insulating layer 4.

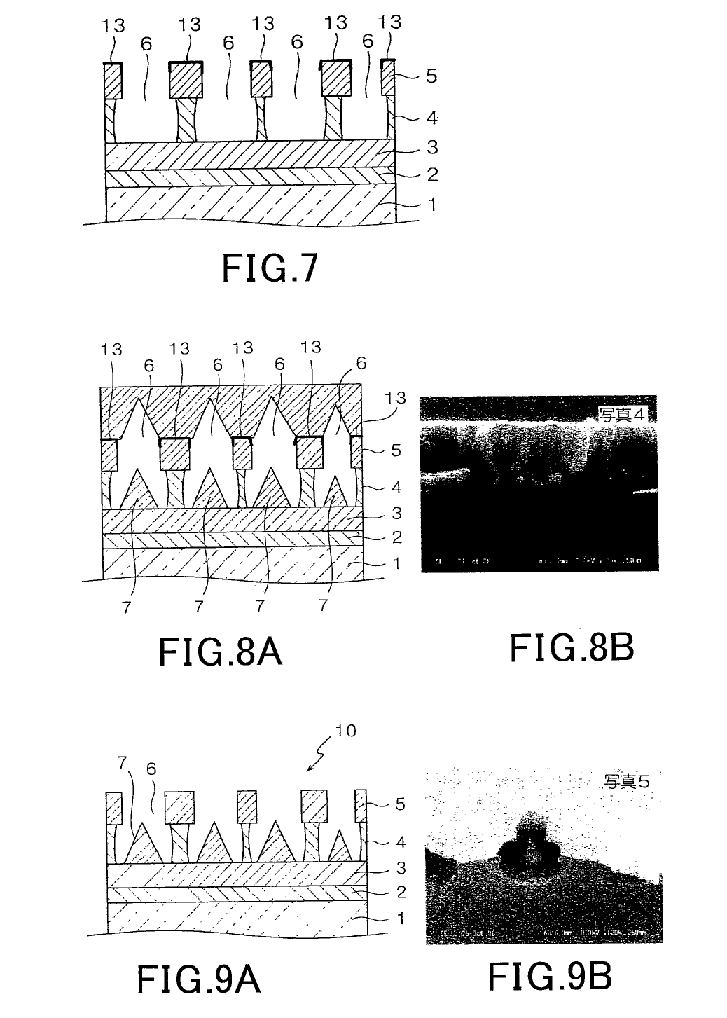

Referring to FIG. 7A, during the deposition of a molybdenum coating on the gate electrode layer 5 having the hole 6 extending therethrough for the purpose of forming an emitter 7, a sacrifice layer 13 is formed so as to peel off and remove the molybdenum which is accumulated on the gate electrode layer 5. In the embodiment, aluminum is employed as material for the sacrifice layer 13, and is only deposited on the gate electrode layer 5 by means of an oblique deposition technology. The thickness of the sacrifice layer 13 may be about 100 Å

Referring to FIG. 8A, a molybdenum layer or coating is deposited from above the gate electrode layer 5 which is covered with the sacrifice layer 13. In other words, a molybdenum coating is deposited onto the gate electrode layer 5 in a direction generally perpendicular to the surface of the substrate 1 while the overall substrate 1 is rotated by a rotatable table (not shown) on which the substrate 1 is disposed. The molybdenum coating is also deposited on the surface of the resistive layer 3 which is exposed to outside via the hole 6, thereby forming the cone-shaped emitter 7 on the resistive layer 3. At the same time, the molybdenum coating is also deposited on the sacrifice layer 13 that is disposed on the gate electrode layer 5. FIG. 8B (Photograph 4) shows that the cone-shaped emitter 7 is formed inside the hole 6 on the resistive layer 3, and the molybdenum coating is also deposited on the gate electrode layer 5.

Referring to FIG. 9A, the sacrifice layer 13 is selectively dissolved by alkaline solution so as to eliminate the molybdenum coating except for the emitter 7. FIG. 9B (Photograph 5) shows that the molybdenum coating deposited on the gate electrode layer 5 is eliminated, and the emitter 7 is formed on the resistive layer 3 within the hole 6.

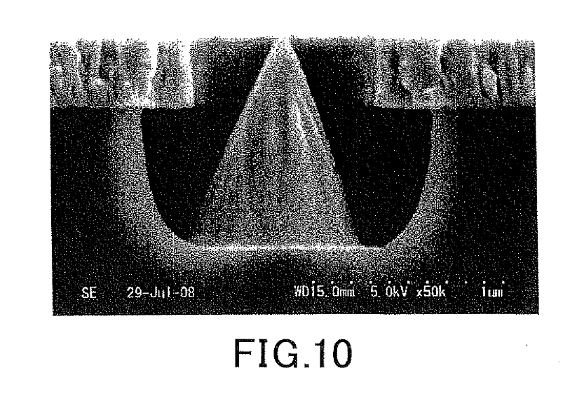

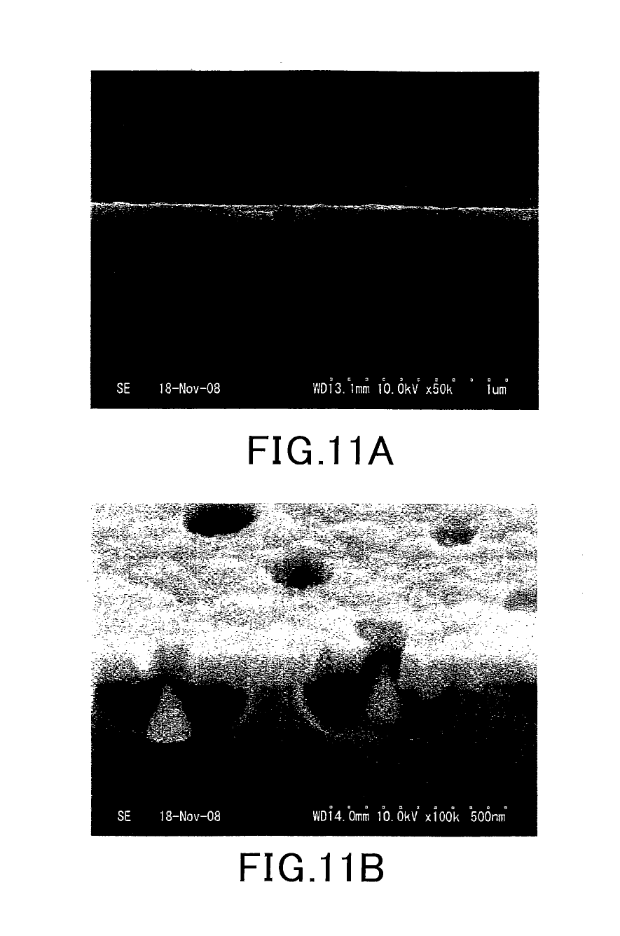

FIG. 10 is an electron micrograph showing a cross section of a conventional cold cathode electron emission source in which a hole extending through both a gate electrode layer and an insulating layer has an opening diameter of about 1 μm. FIG. 11A is an isometric electron micrograph of FIG. 10, showing a cross section of a cold cathode electron emission source 10 produced by the embodiment of the method in accordance with the present invention. As is obvious from the drawings, the cold cathode electron emission source 10 in accordance with the embodiment is remarkably small in comparison with the conventional cold cathode electron emission source as shown in FIG. 10. Moreover, as shown in FIG. 11B, the cold cathode electron emission source 10 in accordance with the embodiment includes the holes 6 having their diameters which are varied and distributed within a predetermined range. On the other hand, the conventional cold cathode electron emission source as shown in FIG. 10 or disclosed in Publication of Japanese Patent Application No. H9-504900A includes holes each of which has a uniform diameter.

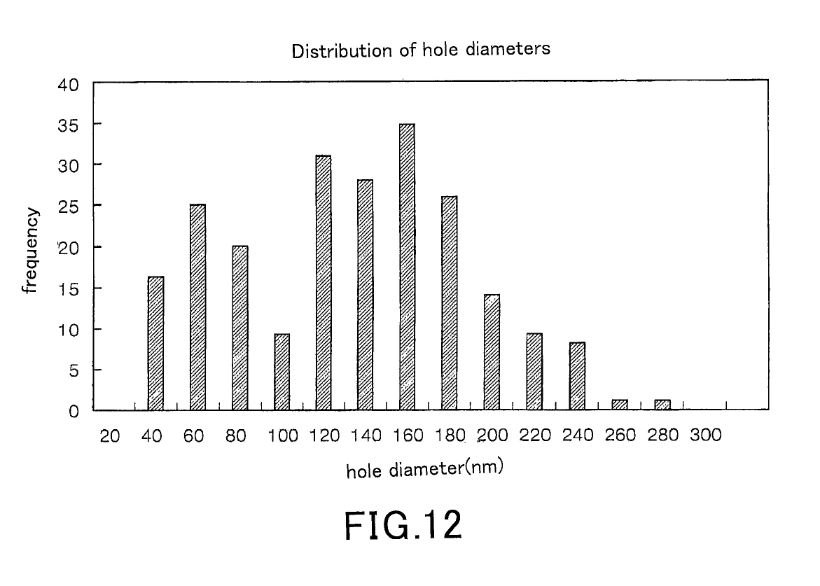

FIG. 12 is a histogram showing an exemplary hole diameter distribution in a cold cathode electron emission source 10 produced by the embodiment of the method in accordance with the present invention. According to this histogram, the diameters of the holes are distributed in the range of from about 40 nm (0.04 μm) to about 300 nm (0.3 μm).

Because the cold cathode electron emission source 10 in accordance with the embodiment of the present invention has the holes 6 extending through the gate electrode layer 5 and having different diameters in the range of from 40 to 300 nm, both the diameter of the hole 6 extending through the insulating layer 4, and the size of the emitter 7 correspondingly varies in a predetermined range. This beneficially allows for constant electron emission with respect to a predetermined drive voltage in spite of moderate processing variations which may increase or decrease the dimensions or diameters of the holes 6. In other words, a phenomenon that an electron is not emitted at all by any of electron emission elements can be securely prevented, and an electron is constantly emitted by at least any of the emitters 7, thereby making drive control easier.

Moreover, with use of the cold cathode electron emission source 10 in accordance with the embodiment of the present invention, a conventional large-scale, cost-consuming apparatus such as an irradiation device for a charged particle is not needed any more. Also, the following advantages are further achieved by forming a plurality of the holes 6 having diameters varying in the range of from 0.04 μm to 0.3 μm in the gate electrode layer 5 with less cost, time, and steps:
Because the present invention does not require an exposure or electron particle irradiation per unit area, the variation in the diameters of the holes depending on the variation in an exposure condition per unit area is not created, thereby securely preventing the unevenness in display.
Also, because electric field intensity is relatively high, emission can be achieved at a relatively low voltage, thereby lowering drive voltage.
Because the emitter 7 is made small-scale, material for forming a layer therefore may be saved.
Because the number of emitter 7 can be increased per pixel, visual quality may be improved.

Modified Version of the First Embodiment.

In the first embodiment as described above, water-soluble PEI (polyethyleneimine) and water-insoluble PMMA (polymethyl methacrylate) were respectively employed as the polymer A and the polymer B, and PGMEA (propylene glycol monomethyl ether acetate) and methanol were employed as the organic solvent component which can dissolve the polymers A and B therein.

However, suitable material for use as the polymers and the organic solvent in accordance with the present invention is not limited the above material. For example, the material as listed below can be also employed in accordance with the present invention. Briefly, any combination of the polymer and the organic solvent as listed below would exhibit the effects and advantages similar to those of the first embodiment.

Water-soluble Polymer (Polymer A)

PVP (Polyvinyl pyrrolidone)

HPC (Hydroxy Propyl Cellulose)

PVA (Polyvinyl Alcohol)

PEG (Polyethylene Glycol)

PEI (polyethylene imine) and the like

Water-insoluble Polymer (Polymer B)

EC (Ethyl cellulose)

PMMA (polymethyl methacrylate)

PC (polycarbonate)

PET (Polyethylene Terephthalate)

polyethylene

polystyrene

Among the combination of the polymer A and the polymer B as listed above, the combinations of PEI and PMMA, PVP and EC and HPC and PMMA are particularly preferred.

Next, the organic solvent suitable for use in the present invention should allow for dissolution of the polymers A and B together such that the polymer A is dispersed in the polymer B at the molecular level. Preferably, the organic solvents as listed below may be employed in accordance with the present invention.

Relatively High Boiling Point Organic Solvent

PGMEA (propylene glycol monomethyl ether acetate)

PGME (Propylene Glycol Monomethyl Ether)

terpineol

ethyl lactate

butyl acetate

These organic solvents may be employed independently or in combination thereof. Each of the above organic solvents basically has a boiling point above or equal to 100° C., and a relatively high vapor pressure. Because the water-soluble polymer A has less solubility than the water-insoluble polymer B in terpineol, the water-soluble polymer A may preferentially precipitate during drying the polymer solution which is applied onto the desired surface. Accordingly, terpineol may be suitable for use as a single or independent organic solvent in accordance with the present invention. On the other hand, relatively low boiling point organic solvent as listed below may be employed in combination with the relatively high boiling point organic solvent as mentioned above for the purpose of controlling solubility of the water-soluble polymer A in the organic solvent.

Relatively Low Boiling Point Organic Solvent

IPA (isopropyl alcohol)

alcohols including methanol

chloroform

When the combination of the relatively high boiling point organic solvent and the relatively low boiling point organic solvent are employed as the solvent for dissolving both the water-soluble polymer A and the water-insoluble polymer B in accordance with the present invention, it should be selected such that the water-soluble polymer A has a greater solubility than the water-insoluble polymer B in the relatively low boiling point organic solvent, and the water-insoluble polymer B has a greater solubility than the water-soluble polymer A in the relatively high boiling point organic solvent. This is because after applying the polymer solution, due to phase separation the water-soluble polymer A preferentially precipitates in the form of particulate during the evaporation of the organic solvent (i.e., drying step). Subsequently, the water-soluble polymer precipitate may be dissolved and removed by a developer so that the mask suited for use in the etching process, as described in the first embodiment, may be prepared.

In other words, not only a single solvent but also a combination of solvents may be employed in the embodiment in accordance with the present invention, if due to difference in solubility one of the polymers is separated from the other polymer, and is preferentially precipitated in the form of particulate during drying the polymer solution (i.e., evaporation of solvent used).

Second embodiment of a method for the manufacture of a cold cathode electron emission source in accordance with the present invention.

This embodiment (i.e., second embodiment) can be carried out in a similar manner to the first embodiment except that the polymer particulate precipitates are developed, and removed by use of a developer.

In this embodiment, any water-soluble polymer component as listed above may be used. Moreover, PC (polycarbonate) was employed as the water-insoluble polymer component, and the combination of PGMEA (propylene glycol monomethyl ether acetate) and IPA (isopropyl alcohol) was employed as the solvent for dissolving both the water-soluble polymer and the water-insoluble polymer. IPA was employed as the developer.

It has been demonstrated that this embodiment also achieves and exhibits effects and advantages similar to those of the first embodiment.

Third embodiment of a method for the manufacture of a cold cathode electron emission source in accordance with the present invention.

This embodiment (i.e., third embodiment) can be carried out in a similar manner to the first embodiment except for the process for forming the emitter 7. In further detail, while in the first embodiment the molybdenum layer is deposited on the sacrifice layer 13, which is disposed on the gate electrode layer 5, so as to form the spindt-type emitter 7, a carbon nanotube layer is deposited on the resistive layer 3 which is exposed to the inside of the hole 6 which extends through the gate electrode layer 5 and the insulating layer 4 so as to form the emitter 7 having a shape differing from the afore-mentioned spindt-type emitter in accordance with this embodiment.

It has been also demonstrated that this embodiment achieves and exhibits effects and advantages similar to those of the first embodiment.

Forth embodiment of a method for the manufacture of a cold cathode electron emission source in accordance with the present invention.

This embodiment (i.e., fourth embodiment) can be carried out in a similar manner to the first embodiment except that the aluminum protective layer 12 (see FIG. 3) is not provided on the polymer B prior to the reactive ionic etching process as shown in FIG. 4. In this case, the water-insoluble polymer B suitable for use in this embodiment may be selected such that it exhibits sufficient etching resistance properties. For example, the polymer B suitable for use in this embodiment may includes, but is not limited to, polycarbonates, polystyrenes, novolac resins, and aryl group-containing polymers. However, the water-soluble polymer A may be selected among the polymers as listed above with respect to the first embodiment, without limitation. Moreover, the organic solvent may be selected among the solvents as listed above with respect to the first embodiment.

It has been also demonstrated that this embodiment achieves and exhibits effects and advantages similar to those of the first embodiment.

Several advantages and effects with respect to the present invention will be hereinafter described.

In accordance with the first aspect of the invention, the layer of the second polymer having a plurality of fine etching holes diameters of which are distributed over a desired range. Because etching process is performed via the etching holes, fine holes having diameters varying over a desired range can be successfully formed in the second conductive layer having a measure of area at a time.

In accordance with one modified or preferred version of the inventive method (i.e., the first aspect of the invention), single organic solvent may be employed as the solvent. Accordingly, due to difference in solubility the first polymer is preferentially precipitated during the evaporation of the organic solvent.

In accordance with another modified or preferred version of the inventive method (i.e., the first aspect of the invention), the solvent may comprise a first organic solvent having a relatively high boiling point and a second organic solvent having a relatively low boiling point. Moreover, the first polymer has solubility greater than the second polymer in the second organic solvent, and the second polymer has solubility greater than the first polymer in the first organic solvent. Accordingly, the first polymer is preferentially precipitated as the organic solvent is evaporated off.

In accordance with still another modified or preferred version of the inventive method (i.e., the first aspect of the invention), the method further includes the step of forming a protective layer on the layer of the second polymer having the etching hole therein prior to the dry etching so as to protect the layer of the second polymer against the dry etching. Accordingly, even if the second polymer having less dry etching resistance properties were employed, substantial damage to the surface of the second polymer layer to be left after etching process can be avoided. In other words, the etching is only subjected to the second polymer which remains at the bottom of the etching hole, the second conductive layer below the second polymer which is disposed at the bottom of the etching hole, and the second conductive layer which is exposed to the inside of the etching hole.

In accordance with the second aspect of the invention, because the holes have diameters varying over a range of from 0.04 μm to 0.3 μm, the cold cathode electron emission source is fabricated in such a way that the sizes of the electron emission elements are varied within the predetermined range. This advantageously allows for constant and successive electron emission with respect to a predetermined drive voltage in spite of moderate processing variations which may increase or decrease the dimensions or diameters of the holes. In contrast, in a case where holes have relatively uniform diameters, there is a possibility that electron emission is not achieved from any of electron emission elements.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

We claim:

1. A method of preparing a cold cathode electron emission source comprising a first conductive layer; an insulating layer on the first conductive layer; a second conductive layer disposed on the insulating layer and having a hole extending therethrough and through the insulating layer; and an emitter formed on a bottom of the hole and positioned in electrical contact with the first conductive layer, comprising the steps of:
dissolving a first polymer and a second polymer, which is incompatible or immiscible with the first polymer, in solvent to obtain a polymer solution, and applying the polymer solution onto the second conductive layer prior to forming the hole, wherein the solvent is selected such that the second polymer has greater solubility than the first polymer in the solvent;
precipitating and immobilizing the first polymer in a form of particulate in the second polymer by evaporating the solvent;
removing the first polymer in the form of particulate by using a developer to form an etching hole in a layer of the second polymer, wherein the developer is selected such that the first polymer has greater solubility than the second polymer in the developer; and
performing etching process via the etching hole to form the hole in the second conductive layer.

2. The method according to claim 1, the developer is water.

3. The method according to claim 1, the developer is organic solvent.

4. The method according to claim 1, the solvent is composed of single organic solvent.

5. The method according to claim 1, the solvent comprises first organic solvent having a relatively high boiling point and second organic solvent having a relatively low boiling point, wherein the first polymer has solubility greater than the second polymer in the second organic solvent, and the second polymer has solubility greater than the first polymer in the first organic solvent.

6. The method according to claim 1, the etching process is dry etching process, and the method further includes forming a protective layer on the layer of the second polymer having the etching hole therein prior to the dry etching so as to protect the layer of the second polymer against the dry etching.

7. A cold cathode electron emission source, comprising a first conductive layer; an insulating layer on the first conductive layer; a second conductive layer disposed on the insulating layer and having holes extending therethrough and through the insulating layer;
and an emitter formed on a bottom of each of the holes and positioned in electrical contact with the first conductive layer, wherein the holes have diameters varying over a range of from 0.04 μm to 0.3 μm.
